(19) United States
(12) Patent Application Publication
(10) Pub. No.: US 2014/0347189 A1
(43) Pub. Date: Nov. 27, 2014

(54) PORT IDENTIFIER SYSTEM AND METHOD

(71) Applicant: Lenovo (Singapore) Pte. Ltd., Singapore (SG)

(72) Inventors: Arnold S. Weksler, Raleigh, NC (US); Russell Speight VanBlon, Raleigh, NC (US); John Carl Mese, Cary, NC (US); Nathan J. Peterson, Durham, NC (US)

(73) Assignee: Lenovo (Singapore) Pte. Ltd., Singapore (SG)

(21) Appl. No.: 13/899,248

(22) Filed: May 21, 2013

(51) Int. Cl. G08B 5/36; H04M 1/725

(52) U.S. Cl. CPC G08B 5/36; H04M 1/72563
USPC 340/687; 439/489; 455/566

(57) ABSTRACT

A device includes a container having multiple different types of ports. A cable detection transceiver may be used to receive signals from a cable near the container. A visual indicator is coupled to the cable detection transceiver to provide a visual indication of a port corresponding to the cable near the container. A cable may contain a near field transmitter coupled proximate the connector to transmit signals representative of the connector.

### BACKGROUND

Electronic devices today have many different ports that may be used to connect other devices to an electronic device. Examples include computer systems that have multiple USB ports, including USB2 and USB3 ports that look alike, yet provide vastly different connection speeds. Other ports include HDMI ports, Ether net ports, memory card ports and others. Sometimes power is provided via a cable which may appear to plug into different ports on a computer with potential harmful effects. Other devices that may have multiple ports include home entertainment systems, amplifiers, cable boxes, and many other types of devices. Some prior solutions to identifying the proper port for a cable include labels on the device. Such labels can also be confusing, resulting in frustration when trying to connect devices to each other.

### SUMMARY

A device includes a container having multiple different types of ports. A cable detection transceiver may be used to receive signals from a cable near the container. A visual indicator is coupled to the cable detection transceiver to provide a visual indication of a port corresponding to the cable near the container. A cable may contain a near field transmitter coupled proximate the connector to transmit signals representative of the connector.

A method includes transmitting a cable detection signal, receiving a response from a proximate cable identifying a cable type, and providing a visual indication of a port corresponding to the identified cable type.

### BRIEF DESCRIPTION OF THE DRAWINGS

FIG. 1 is a block diagram of a device having multiple ports with port indicators according to an example embodiment.

FIG. 2 is a block diagram of an alternative device having multiple ports with port indicators according to an example embodiment.

FIG. 3 is a flowchart illustrating a method of identifying ports according to an example embodiment.

FIG. 4 is a block diagram of an example processing device to implement functions and methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A device has multiple ports for plugging multiple cables with connectors into. The cables may be equipped with active or passive transmitters that identify the type of cable when positioned near the device. The device may include one or more transceivers that receive information from the cable transmitters. Examples of transceivers and transmitters include RFID based devices as well as other near field communication devices. The information received from the cable transmitters is used to provide an indication of the proper port or ports for the cable to be plugged into. The indication may include a light near or integrated into the port that lights up, or a display device that shows a graphical representation of the device with the proper port or ports highlighted. In some embodiments, the display may provide a list of ports identified by one or more alphanumeric characters or other symbols that are located physically proximate the corresponding ports to clearly identify the ports.

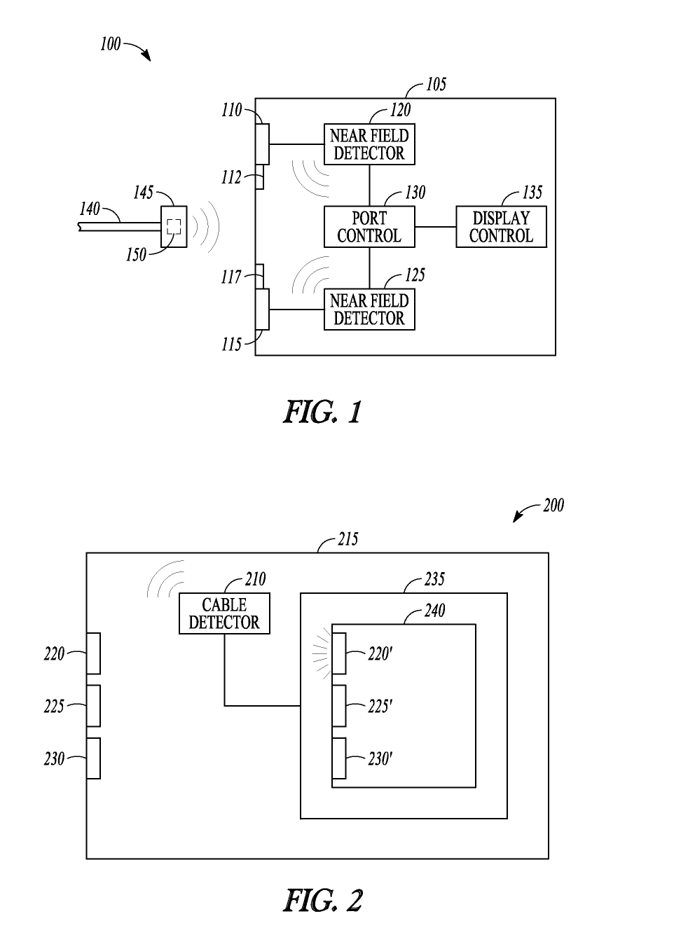

FIG. 1 is a block diagram of a device 100 that includes a container 105 having multiple ports 110, 115 with port indicators 112 and 117 respectively. In one embodiment, the device 100 may be a personal computer, laptop, smart phone, tablet, gaming device, desktop computer, or an entertainment device such as a cable box, television, amplifier, speaker or other device. The ports may include typical computer ports, such as USB2, USB3, HDMI, Ethernet, VGA, power, microphone, speaker, or other computer related ports. Entertainment device ports may also include HDMI, RGB, Ethernet, speaker, or other ports.

Port indicators 112 and 117 may include light emitting diodes or other light emitting devices to provide a visual indication of the proper port for a cable when the cable nears the device, or even based on proximity to a particular port. In one embodiment, the ports are coupled to respective near field detectors 120 and 125 respectively. The near field detectors in one embodiment are RFID transmitters that transmit signals the when received by RFID chips, cause the RFID chips to transmit information identifying the cable. This information is then received by the near field detectors 120, 125 and passed on to a port control device 130. The port control device the causes the port indicators 112 and 117 to emit light at the port corresponding to the cable. Once the cable is plugged into a proper port, the port control 130 stops the indicators from providing a visual indication. The visual indication may also, or alternatively be transmitted via a display control 135 to a visual display system to identify on the visual display which port or ports are the proper ports.

In some embodiments, each port has an associated near field detector, which may be activated via port control 130 periodically, or when a device is placed into a plug in cable mode by a user. Each near field detector may have a range of a few inches or so that causes each port to light up only when the cable is quite near the port. In further embodiments, a single near field detector 120 may be used having a detection distance sufficient to detect cables that are brought near device 100 in a manner commonly associated with a user trying to determine which port the cable may be plugged into. The single near field detector 120 may also periodically transmit signals seeking proximate cable transmitters, or may also be activated by a user desiring to plug in a cable.

A cable 140 is indicated as nearing the device 100. The cable 140 includes a connector portion 145 and a transmitter 150, which is shown positioned on the connector portion 145, but may also be placed on the cable near the connector portion 145 in further embodiments. When it receives a signal from a near field detector, such as an RFID detector, the transmitter may draw power from the transmitter and transmit information identifying the type of cable and connector. This identifying information is received by the RFID detector and decoded to identify the proper port or ports. For instance, if the cable is a USB 2 cable, the ports on the device which can accept a USB2 cable are visually indicated. This would include USB2 ports and USB3 ports, because USB3 ports can also receive USB2 cables. If a USB3 cable is brought near the device, only USB3 ports will be visually identified.

FIG. 2 is a block diagram of a device 200 having a cable detector 210 to detect cables near the device. The cable detector 210 is disposed within a container 215 such as a laptop shell, touchpad case, or other electronic enclosure. The container 215 has multiple ports 220, 225, 230 to receive cables. In one embodiment, the device 200 is a tablet device having a touchscreen 235. The touch screen is shown cut away in one portion to expose the cable detector 210. In this view of the device 210, a visual indication of a port corresponding to a cable is shown on the touchscreen or other type of display. At 240, a graphic representation of the device is shown with the ports identified at 220′, 225′, 235′ respectively for ports 220, 225, 235. In this representation, a cable that corresponds to port 220 has been brought near the device 200, has been identified, and the corresponding representation 220′ is shown with an attribute, such as being brighter than the other representations, is blinking, or is otherwise identified to communicate to a user that it is the proper port for the cable.

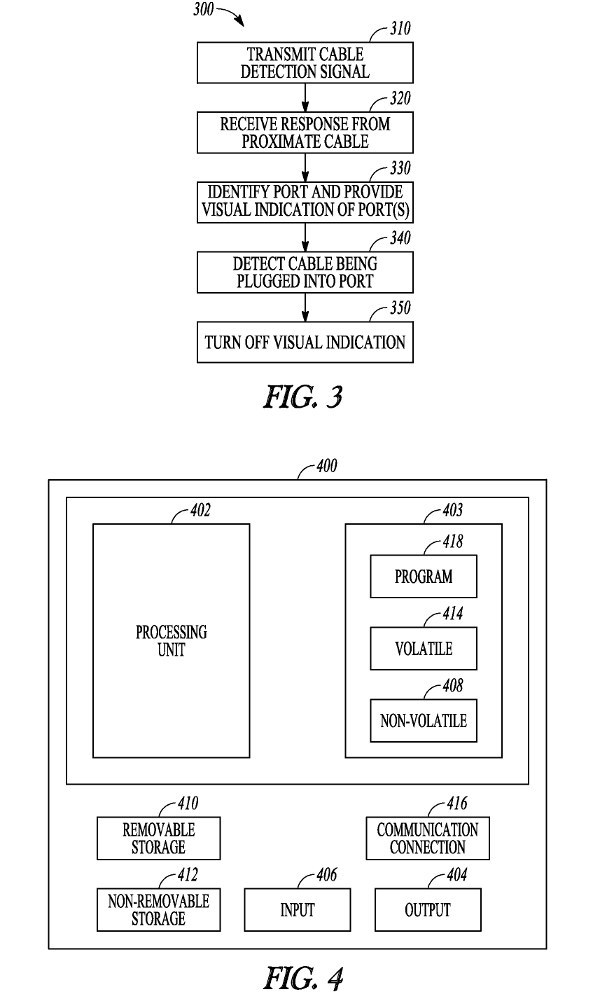

FIG. 3 is a flowchart illustrating a method 300 of detecting cables proximate a device to which the cable is to be attached. Method 300 in one embodiment causes a device to transmit a cable detection signal at 310. The device may periodically, such as for example every 5 seconds or less, transmit a cable detection signal. The length of time may be more or less, and may be selected to ensure a user of the device does not have to wait too long to determine which connector corresponds to the cable. In some embodiments, the cable detection signal may be transmitted with a period or time between tranmissions of less than one second. In further embodiments, a device may have a proximity detector to trigger cable detection when a cable is brought near a computer. In still further embodiments, pressing a key or touch screen of a device may cause the signals to be transmitted. In still further embodiments, a function may be selected by a user to cause transmission of the signal.

At 320, a response is received from a proximate cable identifying a cable type. Whether or not a response from a cable is received is dependent on the strength of the cable detection signal transmission. That strength may be selected based on how far from a device or port a cable is desired to be before identifying a corresponding port or ports. In some embodiments, a range of one foot or less may be desired, with the transmission strength being adjusted correspondingly. In further embodiments, that range may be more or less than one foot. It may be a matter of inches in further embodiments, similar to card readers.

At 330, the device identifies a port or ports corresponding to the cable detected and causes a visual indication of a port corresponding to the identified cable type to be provided. The visual indication may be a light positioned close to each corresponding port that is clearly associated with the port, or may be a visual display on a display device of the device that provides sufficient information to a user to enable them to quickly identify the port or ports that correspond to the cable. Further information may be provided in such a display, such as indicated a port that provides for faster data transfer, such as a USB3 port, since both USB3 and USB2 ports utilize the same physical connectors. Ports in one embodiment include a USB2 port, a USB3 port, and an HDMI port.

In a further embodiment, the device detects at 340 that the cable has been plugged into a corresponding port. At 350, following detection of the cable being plugged in, the visual indication or indications may be turned off. Signals from that cable may also be ignored from that point in time on. In further embodiments, the cable may detect when it has been plugged in, and may discontinue responding to detection signals. The cable may include sensing circuitry to detect current flowing through the cable, which can only occur when the cable is plugged in. In still further embodiments, different types of cables may be configured to reply to detection signals with different delays in response to being interrogated by a detection signal. Such different delays may aid in detecting which cable is not yet plugged in. In still further embodiments, if multiple cables are brought near enough the device to be detected, the device may provide a message to the user via sound or visual indicators that one cable at a time should be near the device to help avoid conflicts in determining which port or ports correspond to a cable.

In some embodiments, the cable detection signal comprises an RFID detector signal. The visual indication is a light emitting diode positioned near the corresponding port in one embodiment. It may be positioned above the port on a top surface of a device, next to the port, inside the port, or any other place where it effectively communicates which port or ports correspond to the cable.

FIG. 4 is a block schematic diagram of a computer system 400 to implement functions and execute methods according to an example embodiment. In one embodiment, a simple microprocessor may be used. One example computing device in the form of a computer 400 may include a processing unit 402, memory 403, removable storage 410, and non-removable storage 412. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input 406, output 404, and a communication connection 416. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### EXAMPLES

1. A device comprising:
a container having multiple different types of ports;
a cable detection transceiver to receive signals from a cable near the container; and
a visual indicator coupled to the cable detection transceiver to provide a visual indication of a port corresponding to the cable near the container.

2. The device of example 1 wherein the visual indicator comprises multiple lights, each light positioned proximate a port.

3. The device of example 2 wherein the ports and visual indicators are positioned on an exterior portion of the container.

4. The device of any of examples 1-3 wherein the device comprises a laptop computer.

5. The device of any of examples 1-3 wherein the device comprises a tablet.

6. The device of any of examples 1-3 wherein the device comprises an entertainment system device.

7. The device of any of examples 1-6 wherein the ports comprise a USB2 port and a USB3 port.

8. The device of example 7 wherein one port is an HDMI port.

9. The device of any of examples 1-8 wherein the visual indicator comprises a display device having a graphical representation of the container and ports, with a port corresponding to the cable near the container has attributes visually identifying it.

10. The device of any of examples 1-9 and further comprising a port controller to activate the corresponding visual indicator and to deactivate the corresponding visual indicator when the cable has been plugged into the port.

11. The device of any of examples 1-10 wherein the cable detection transmitter comprises an RFID detector.

12. The device of any of examples 1-11 wherein the cable detection transmitter has a range corresponding to a cable being placed near the container.

13. A device comprising:
a cable to carry electrical signals;
a connector coupled to the cable to connect to a port on another device; and
a near field transmitter coupled proximate the connector to transmit signals representative of the connector.

14. The device of example 13 wherein the near field transmitter comprises an RFID chip having information representative of the connector stored on a memory of the RFID chip for transmission.

15. A method comprising:
transmitting a cable detection signal;
receiving a response from a proximate cable identifying a cable type; and
providing a visual indication of a port corresponding to the identified cable type.

16. The method of example 15 and further comprising:

detecting that the cable has been plugged into a corresponding port; and turning off the visual indication.

17. The method of any of examples 15-16 wherein the cable detection signal comprises an RFID detector signal.

18. The method of any of examples 15-17 wherein the visual indication comprises a light emitting diode positioned near the corresponding port.

19. The method of any of examples 15-18 wherein providing a visual indication comprises: identifying a port corresponding to the received response; providing a display of a device having multiple ports with the location of the corresponding port identified on the display.

20. The method of any of examples 15-19 wherein the ports comprise a USB2 port, a USB3 port, and an HDMI port.

21. A communication device comprising:
A touch screen display;
a transceiver configured to communicate with other communication devices over a cellular network; and
circuitry coupled to the transceiver, the circuitry configured to detect a lost communication session with another communication device and generate a menu of options regarding the lost communication session for display on the touch screen display;
wherein the touch screen display is configured to receive a user selection of an option.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a container having multiple different types of ports;
a cable detection transceiver to receive signals from a cable near the container; and
a visual indicator coupled to the cable detection transceiver to provide a visual indication of a port corresponding to the cable near the container.

2. The device of claim 1 wherein the visual indicator comprises multiple lights, each light positioned proximate a port.

3. The device of claim 2 wherein the ports and visual indicators are positioned on an exterior portion of the container.

4. The device of claim 1 wherein the device comprises a laptop computer.

5. The device of claim 1 wherein the device comprises a tablet.

6. The device of claim 1 wherein the device comprises an entertainment system device.

7. The device of claim 1 wherein the ports comprise a USB2 port and a USB3 port.

8. The device of claim 7 wherein one port is an HDMI port.

9. The device of claim 1 wherein the visual indicator comprises a display device having a graphical representation of the container and ports, with a port corresponding to the cable near the container has attributes visually identifying it.

10. The device of claim 1 and further comprising a port controller to activate the corresponding visual indicator and to deactivate the corresponding visual indicator when the cable has been plugged into the port.

11. The device of claim 1 wherein the cable detection transmitter comprises an RFID detector.

12. The device of claim 1 wherein the cable detection transmitter has a range corresponding to a cable being placed near the container.

13. A device comprising:
a cable to carry electrical signals;
a connector coupled to the cable to connect to a port on another device; and
a near field transmitter coupled proximate the connector to transmit signals representative of the connector.

14. The device of claim 13 wherein the near field transmitter comprises an RFID chip having information representative of the connector stored on a memory of the RFID chip for transmission.

15. A method comprising:
transmitting a cable detection signal;
receiving a response from a proximate cable identifying a cable type; and
providing a visual indication of a port corresponding to the identified cable type.

16. The method of claim 15 and further comprising:
detecting that the cable has been plugged into a corresponding port; and
turning off the visual indication.

17. The method of claim 15 wherein the cable detection signal comprises an RFID detector signal.

18. The method of claim 15 wherein the visual indication comprises a light emitting diode positioned near the corresponding port.

19. The method of claim 15 wherein providing a visual indication comprises:
identifying a port corresponding to the received response;
providing a display of a device having multiple ports with the location of the corresponding port identified on the display.

20. The method of claim 15 wherein the ports comprise a USB2 port, a USB3 port, and an HDMI port.

21. A communication device comprising:
A touch screen display;
a transceiver configured to communicate with other communication devices over a cellular network; and
circuitry coupled to the transceiver, the circuitry configured to detect a lost communication session with another communication device and generate a menu of options regarding the lost communication session for display on the touch screen display;
wherein the touch screen display is configured to receive a user selection of an option.
